(19) United States
(12) Patent Application Publication
(10) Pub. No.: US 2024/0098200 A1
(43) Pub. Date: Mar. 21, 2024

(54) IMAGE READING DEVICE

(71) Applicant: Mitsubishi Electric Corporation, Tokyo (JP)

(72) Inventors: Hiroyuki KAWANO, Tokyo (JP); Naoki NAKAGAWA, Tokyo (JP); Takeshi ONO, Tokyo (JP); Shigeru TAKUSHIMA, Tokyo (JP); Taisuke MAKITA, Tokyo (JP); Naoyuki TOKIDA, Tokyo (JP)

(73) Assignee: Mitsubishi Electric Corporation, Tokyo (JP)

(21) Appl. No.: 18/272,604

(22) PCT Filed: Jan. 25, 2021
(86) PCT No.: PCT/JP2021/002391

§ 371 Date: Jul. 17, 2023

(51) Int. Cl. H04N 1/191; H04N 1/03; H04N 1/031

(52) U.S. Cl. CPC H04N 1/1918; H04N 1/0306; H04N 1/031; H04N 2201/03145

(57) ABSTRACT

An image reading device (100) includes a first glass member (52), a plurality of condensing lenses (14) provided on a first surface (52a) of the first glass member (52), a first light blocking member (12) having a plurality of first openings (32) respectively corresponding to the plurality of condensing lenses (14), a second glass member (51) having a third surface (51a) in superimposition with the first light blocking member (12), a second light blocking member (11) having a plurality of second openings (31) respectively corresponding to the plurality of first openings (32), a third glass member (53) having a fifth surface (53a) in superimposition with the second light blocking member (11), a third light blocking member (15) having a plurality of third openings (34) respectively corresponding to the plurality of second openings (31), and a sensor unit (3) having a sensor substrate (9) and a plurality of light receiving pixels (10) arrayed in a predetermined array direction on the sensor substrate (9) and respectively corresponding to the plurality of third openings (34).

### TECHNICAL FIELD

The present disclosure relates to an image reading device.

### BACKGROUND ART

There has been proposed an image reading device including a glass member, a plurality of lenses provided on the glass member, a light absorption layer as a light blocking member having a plurality of openings respectively corresponding to the plurality of lenses, and a plurality of light receiving pixels. See Patent Reference 1, for example.

### PRIOR ART REFERENCE

### Patent Reference

Patent Reference 1: Japanese Patent Application Publication No. 63-1.56473

### SUMMARY OF THE INVENTION

### Problem to be Solved by the Invention

However, when a linear expansion coefficient of the glass member provided with the plurality of lenses and a linear expansion coefficient of a sensor substrate provided with the light receiving pixels differ from each other, there is a danger that an optical axis of each condensing lens included in the plurality of lenses deviates from a center of each of the plurality of light receiving pixels due to a temperature change. In this case, there is a problem in that part of light traveling towards the light receiving pixel deviates from a light receiving region of the light receiving pixel and that causes a decrease in the amount of light received by each light receiving pixel.

An object of the present disclosure is to prevent the decrease in the amount of light received by each light receiving pixel.

### Means for Solving the Problem

An image reading device according to an aspect of the present disclosure includes a first glass member having a first surface and a second surface as a surface on a side opposite to the first surface, a plurality of condensing lenses provided on the first surface, a first light blocking member provided on the second surface and having a plurality of first openings respectively corresponding to the plurality of condensing lenses, a second glass member having a third surface in superimposition with the first light blocking member, a second light blocking member provided on a fourth surface as a surface of the second glass member on a side opposite to the third surface and having a plurality of second openings respectively corresponding to the plurality of first openings, a third glass member having a fifth surface in superimposition with the second light blocking member, a third light blocking member provided on a sixth surface as a surface of the third glass member on a side opposite to the fifth surface and having a plurality of third openings respectively corresponding to the plurality of second openings, and a sensor unit having a sensor substrate and a plurality of light receiving pixels arrayed in a predetermined array direction on the sensor substrate and respectively corresponding to the plurality of third openings.

An image reading device according to another aspect of the present disclosure includes a first glass member having a first surface and a second surface as a surface on a side opposite to the first surface, a plurality of condensing lenses provided on the first surface, a first light blocking member provided on the second surface and having a plurality of first openings respectively corresponding to the plurality of condensing lenses, a second glass member having a third surface in superimposition with the first light blocking member, a second light blocking member provided on a fourth surface as a surface of the second glass member on a side opposite to the third surface and having a plurality of second openings respectively corresponding to the plurality of first openings, a third glass member having a fifth surface in superimposition with the second light blocking member, and a sensor unit having a plurality of light receiving pixels arrayed in a predetermined array direction and respectively corresponding to the plurality of second openings. The plurality of light receiving pixels are bonded to a sixth surface as a surface on a side opposite to the fifth surface.

### Effect of the Invention

According to the present disclosure, the decrease in the amount of light received by each light receiving pixel can be prevented.

### BRIEF DESCRIPTION OF THE DRAWINGS

FIG. 1 is a perspective view schematically showing a configuration of an image reading device according to a first embodiment.

FIG. 2 is a cross-sectional view of the image reading device shown in FIG. 1 taken along the line A2-A2.

FIG. 3 is a cross-sectional view of the image reading device shown in FIG. 1 taken along the line A3-A3.

FIG. 4 is a plan view showing a part of a configuration of an imaging element unit shown in FIG. 1.

FIG. 5 is a diagram schematically showing a configuration of an illumination optical unit shown in FIG. 1 and illuminating light emitted from the illumination optical unit.

FIG. 6 is a diagram showing a part of the configuration of the image reading device shown in FIG. 3 and reflected light passing through second openings and first openings.

FIGS. 7A and 7B are diagrams for explaining conditions for the reflected light after passing through a second opening and a first opening corresponding to a light receiving pixel to enter the light receiving pixel in the image reading device according to the first embodiment.

FIG. 8 is a cross-sectional view of the image reading device shown in FIG. 1 taken along the line A8-A8.

FIG. 9 is a diagram schematically showing reflected light entering a light receiving pixel shown in FIG. 3.

FIG. 10 is a diagram showing inverse rays as virtual rays heading in a +Z-axis direction from a light receiving pixel in the image reading device according to the first embodiment.

FIG. 11 is a diagram showing broadening of the inverse rays shown in FIG. 10.

FIG. 12A is a diagram schematically showing reflected light entering a light receiving pixel in an image reading device according to a first comparative example.

FIG. 12B is a schematic diagram schematically showing reflected light entering a light receiving pixel in an image reading device according to a second comparative example.

FIG. 13 is a diagram schematically showing reflected light entering a light receiving pixel in the image reading device according to the first embodiment.

FIG. 14 is a diagram showing a part of the configuration of the image reading device shown in FIG. 3 and the reflected light entering the light receiving pixel.

FIG. 15 is a diagram showing a part of a configuration of an image reading device according to a third comparative example and reflected light entering a light receiving pixel.

FIG. 16A is a diagram showing the relationship between the light receiving pixel shown in FIG. 14 and an irradiation region of the reflected light entering the light receiving pixel when a temperature change amount is 0° C.

FIG. 16B is a diagram showing the relationship between the light receiving pixel and the irradiation region of the reflected light entering the light receiving pixel when the temperature change amount is 40° C.

FIG. 17A is a diagram showing the relationship between the light receiving pixel shown in FIG. 15 and the irradiation region of the light entering the light receiving pixel when the temperature change amount is 0° C.

FIG. 17B is a diagram showing the relationship between the light receiving pixel and the irradiation region of the light entering the light receiving pixel when the temperature change amount is 40° C.

FIG. 18 is a cross-sectional view showing a configuration of an image reading device according to a second embodiment.

FIG. 19 is a plan view showing a part of the configuration of the image reading device according to the second embodiment.

### MODE FOR CARRYING OUT THE INVENTION

An image reading device according to each embodiment of the present disclosure will be described below with reference to the drawings. The following embodiments are just examples and it is possible to appropriately combine embodiments and appropriately modify each embodiment.

### First Embodiment

### <Configuration of Image Reading Device>

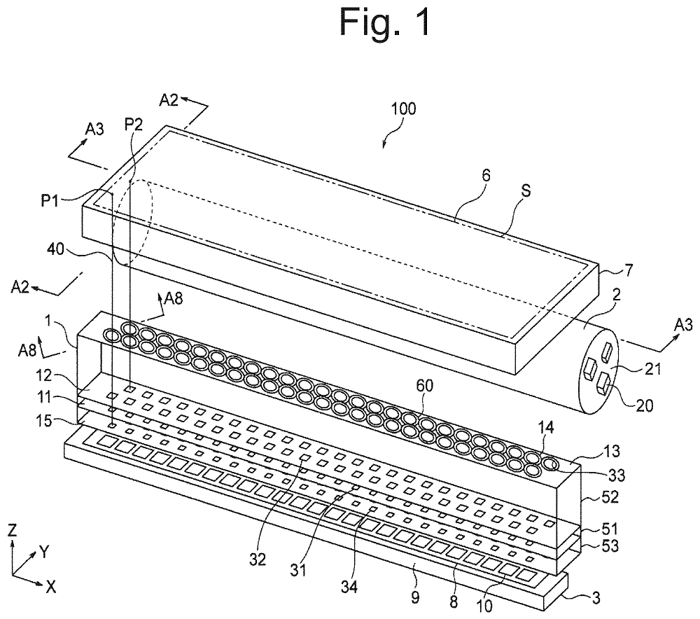

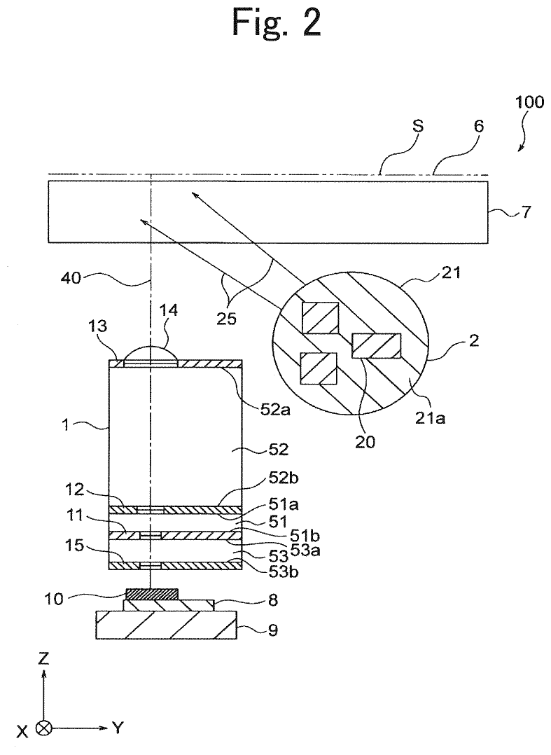

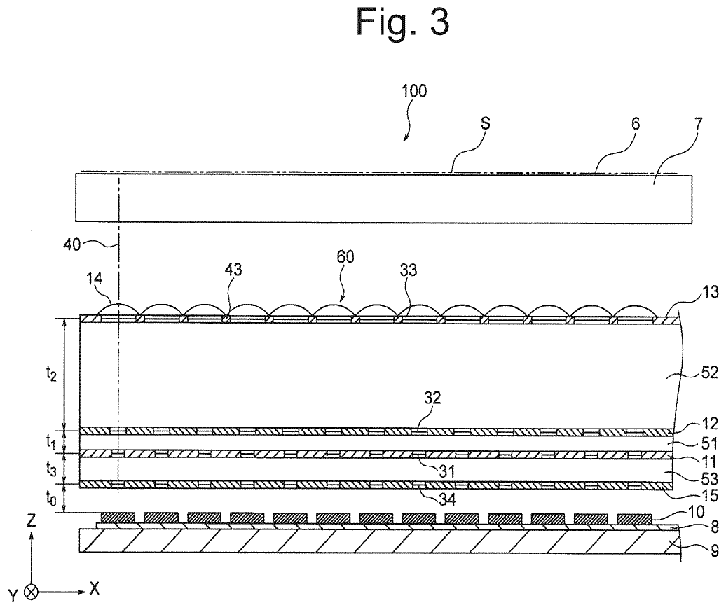

FIG. 1 is a perspective view schematically showing a main configuration of an image reading device 100 according to a first embodiment. FIG. 2 is a cross-sectional view of the image reading device 100 shown in FIG. 1 taken along the line A2-A2. FIG. 3 is a cross-sectional view of the image reading device 100 shown in FIG. 1 taken along the line A3-A3. As shown in FIGS. 1 to 3, the image reading device 100 includes an imaging optical unit 1, an illumination optical unit 2, and a top glass plate 7 as a document setting table. When illuminating light 25 from the illumination optical unit 2 is applied to a document 6 arranged on the top glass plate 7, the illuminating light 25 is scattered and reflected by the document 6. The scattered and reflected light (hereinafter referred to also as “reflected light”) is received by the imaging optical unit 1, by which image information on the document 6 is read out.

In the first embodiment, in order for the imaging optical unit 1 to acquire two-dimensional image information on the document 6, the document 6 is conveyed by a conveyance unit (not shown) along the top glass plate 7 in an auxiliary scanning direction (i.e., Y-axis direction) orthogonal to a main scanning direction (i.e., X-axis direction). This operation makes it possible to scan the whole of the document 6. Incidentally, it is also possible to execute the scan of the whole of the document 6 by moving the imaging optical unit 1 in the Y-axis direction while leaving the document 6 still.

The document 6 is an example of an image capture target that undergoes image capturing by the imaging optical unit 1. The document 6 is, for example, a print that has been printed with characters, an image or the like. The document 6 is arranged on a predetermined reference surface S. The reference surface S is a plane on which the document 6 is set, that is, a plane on the top glass plate 7. The top glass plate 7 is situated between the document 6 and the imaging optical unit 1. The thickness of the top glass plate 7 is 1.0 mm, for example. Incidentally, the structure for setting the document 6 on the reference surface S is not limited to the top glass plate 7.

The image reading device 100 includes a glass member 52 as a first glass member, a plurality of microlenses 14 as a plurality of condensing lenses, a light blocking member 12 as a first light blocking member, a glass member 51 as a second glass member, a light blocking member 11 as a second light blocking member, a glass member 53 as a third glass member, a light blocking member 15 as a third light blocking member, and an imaging element unit 3 as a sensor unit. The glass member 52, the microlenses 14, the light blocking member 12, the glass member 51, the light blocking member 11, the glass member 53, the light blocking member 15 and the imaging element unit 3 constitute the imaging optical unit 1.

The glass member 52 is a light-permeable member through which light can pass, for example, a glass substrate. The glass member 52 has a surface 52a as a first surface and a surface 52b as a second surface as a surface on a side opposite to the surface 52a.

The plurality of microlenses 14 are provided on the surface 52a of the glass member 52. The microlenses 14 have a function of condensing the reflected light reflected by the document 6. The microlens 14 is a convex lens. The plurality of microlenses 14 are arrayed so as to correspond respectively to a plurality of light receiving pixels 10. In the first embodiment, the plurality of microlenses 14 respectively overlap with the plurality of light receiving pixels 10 as viewed in a Z-axis direction.

The plurality of microlenses 14 are arrayed in two lines. The microlenses 14 in each line are arrayed in the X-axis direction. Further, the plurality of microlenses 14 are arrayed in a hound's tooth pattern. In the first embodiment, the diameter of the microlens 14 is set at a predetermined size in a range from some micrometers to some millimeters. The curvature radius of the surface of the microlens 14 is 0.33 mm, for example. The plurality of microlenses 14 arrayed in the hound's tooth pattern constitute a microlens array 60. In FIG. 2, an optical axis of the microlens 14 is represented by a reference character 40.

The light blocking member 12 is provided on the surface 52b of the glass member 52. Namely, the light blocking member 12 is formed on the surface 52b on the light receiving pixels 10's side of the glass member 52. The light blocking member 12 has a plurality of openings 32 as first openings. The reflected light reflected by the document 6 passes through each of the plurality of openings 32. The opening 32 is in a square shape of 80 μm×80 μm, for example. The above-described microlenses 14 are arranged apart from the plurality of openings 32 via the glass member 52 in an optical axis direction (i.e., the Z-axis direction).

The plurality of openings 32 are arranged at positions respectively corresponding to the plurality of microlenses 14. As viewed in the Z-axis direction, the plurality of openings 32 respectively overlap with the plurality of microlenses 14. Further, the plurality of openings 32 are arranged at positions respectively corresponding to the plurality of light receiving pixels 10. As viewed in the Z-axis direction, the plurality of openings 32 respectively overlap with the plurality of light receiving pixels 10. The plurality of openings 32 are arrayed in two lines. The openings 32 in each line are arrayed in the X-axis direction. The plurality of openings 32 are arrayed in the hound's tooth pattern.

The glass member 51 is a light-permeable member through which light can pass, for example, a glass substrate. The glass member 51 has a surface 51a as a third surface in superimposition with the light blocking member 12 and a surface 51b as a fourth surface as a surface on a side opposite to the surface 51a.

The light blocking member 11 is provided on the surface 51b of the glass member 51. Namely, the light blocking member 11 is formed on the surface 51b on the light receiving pixels 10's side of the glass member 51. The light blocking member 11 has a plurality of openings 31 as a plurality of second openings. The reflected light reflected by the document 6 passes through each of the plurality of openings 31. The opening 31 is in a square shape of 40 μm×40 μm, for example.

The plurality of openings 31 are arranged at positions respectively corresponding to the plurality of openings 32. As viewed in the Z-axis direction, the plurality of openings 31 respectively overlap with the plurality of openings 32, and thus the plurality of openings 31 respectively overlap with the plurality of microlenses 14. Further, the plurality of openings 31 are arranged at positions respectively corresponding to the plurality of light receiving pixels 10. As viewed in the 2-axis direction, the plurality of openings 31 respectively overlap with the plurality of light receiving pixels 10. The plurality of openings 31 are arrayed in two lines. The openings 31 in each line are arrayed in the X-axis direction. Furthermore, the plurality of openings 31 are arrayed in the hound's tooth pattern.

A part of the light blocking member 11 excluding the openings 31 is a light blocking part 41 that blocks the reflected light, and a part of the aforementioned light blocking member 12 excluding the openings 32 is a light blocking part 42 that blocks the reflected light. The light blocking part 41 and the light blocking part 42 are light blocking layers as thin films formed by chrome oxide films vapor-deposited on the glass member 51. The openings 31 and the openings 32 are formed by etching the chrome oxide films vapor-deposited on the glass member 51 by using mask patterns.

The glass member 53 is a light-permeable member through which light can pass, for example, a glass substrate. The glass member 53 is arranged on the light receiving pixels 10's side relative to the glass member 51. The glass member 53 has a surface 53a as a fifth surface in superimposition with the light blocking member 11 and a surface 53b as a sixth surface as a surface on a side opposite to the surface 53a.

In the first embodiment, refractive indices of the glass member 51, the glass member 52 and the glass member 53 are at the same value, for example, 1.52. Incidentally, the refractive indices of the glass member 51, the glass member 52 and the glass member 53 may also differ from each other.

The light blocking member 15 is provided on the surface 53b of the glass member 53. The light blocking member 15 has a plurality of openings 34 as a plurality of third openings. The opening 34 is in a square shape of 35 μm×35 μm, for example.

The plurality of openings 34 are arranged at positions respectively corresponding to the plurality of openings 31. As viewed in the Z-axis direction, the plurality of openings 34 respectively overlap with the plurality of openings 31. Further, the plurality of openings 34 are arranged at positions respectively corresponding to the plurality of light receiving pixels 10. As viewed in the Z-axis direction, the plurality of openings 34 respectively overlap with the plurality of light receiving pixels 10. The plurality of openings 34 are arrayed in two lines. The openings 34 in each line are arrayed in the X-axis direction. Furthermore, the plurality of openings 34 are arrayed in the hound's tooth pattern.

A part of the light blocking member 15 excluding the openings 34 is a light blocking part 44 that blocks the reflected light. The light blocking part 44 is a light blocking layer as a thin film formed on the glass member 53. The openings 34 are formed by etching a chrome oxide film vapor-deposited on the glass member 53 by using a mask pattern.

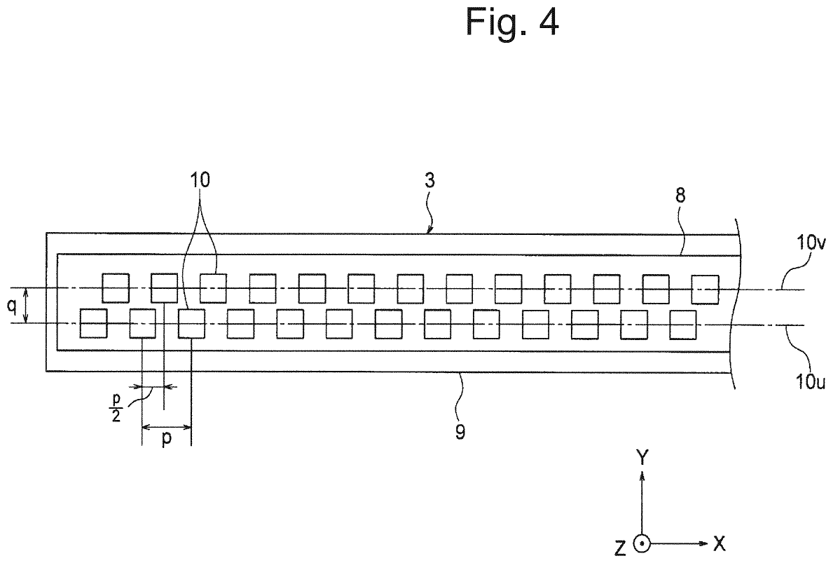

FIG. 4 is a plan view showing a part of the imaging element unit 3 shown in FIG. 1. As shown in FIGS. 1 to 4, the imaging element unit 3 includes a sensor chip 8 as an imaging element chip and a sensor substrate 9 as an imaging element substrate. The sensor chip 8 includes the plurality of light receiving pixels 10. The sensor chip 8 is formed from silicon material, for example. The sensor chip 8 is provided on the sensor substrate 9. The sensor substrate 9 is a mounting substrate made of a light-impermeable member, and is formed from glass epoxy resin, for example. The sensor chip 8 is electrically connected to the sensor substrate 9. The sensor chip 9 is mounted on the sensor substrate 9 by means of wire bonding, for example.

Here, the thickness t₁ of the glass member 51 shown in FIG. 3 is t₁=210 μm, for example. The thickness t₂ of the glass member 52 is t₂=700 μm, for example. The thickness t₃ of the glass member 53 is t₃=210 μm, for example. The glass member 53 is arranged at a distance of t₀ from the light receiving pixels 10 in the Z-axis direction. The spacing to between the glass member 53 and the light receiving pixels 10 is 250 μm, for example.

In the case where the sensor chip 8 is mounted on the sensor substrate 9 by means of wire bonding, wires can stick out from the +Z-axis side surface of the sensor chip 9 in the +Z-axis direction by approximately 100 to 200 μm. In the first embodiment, the spacing to is 250 μm longer than the length of the wires, and thus interference between the wires sticking out from the sensor chip 8 and the glass member 53 can be prevented. In the first embodiment, the spacing t₀=250 μm is secured by arranging a spacer member (not shown) having a thickness of 250 μm between the glass member 53 and the light receiving pixels 10.

As shown in FIGS. 1 to 4, the plurality of light receiving pixels 10 are arranged at positions respectively corresponding to the plurality of openings 34. The plurality of light receiving pixels 10 are arrayed in the X-axis direction as a predetermined array direction. The plurality of light receiving pixels 10 include light receiving pixels 10 in a first line 10u that are arrayed in the X-axis direction and light receiving pixels 10 in a second line 10v that are arrayed in the X-axis direction. Namely, the plurality of light receiving pixels 10 are arrayed in the X-axis direction in two lines. Incidentally, the plurality of light receiving pixels 10 may also be arrayed in the X-axis direction in one line or arrayed in three or more lines.

The light receiving pixels 10 are light receiving elements that receive the reflected light reflected by the document 6. The size of one light receiving pixel 10 (i.e., light receiving region) is 200 μm×200 μm, for example. An X-axis direction interval p between central positions of light receiving pixels 10 adjoining in the X-axis direction is 250 μm, for example. A Y-axis direction interval q between central positions of light receiving pixels 10 is 250 μm, for example.

Further, the plurality of light receiving pixels 10 are arranged at positions in the X-axis direction different from each other. In rig. 4, the plurality of light receiving pixels 10 are arrayed in the hound's tooth pattern. Specifically, the light receiving pixels 10 in the second line 10v are arranged to deviate in the X-axis direction relative to the light receiving pixels 10 in the adjoining first line 10u by a distance p/2 as ½ of the interval p. By this arrangement, each of the light receiving pixels 10 in the second line 10v is situated halfway between adjoining two of the light receiving pixels 10 in the X-axis direction in the first line 10u. Further, since the plurality of light receiving pixels 10 are arrayed in a hound's tooth pattern, the interval between two light receiving pixels 10 adjoining in the X-axis direction can be made wide, and thus an effective diameter of the microlens 14 can be made large. Specifically, the microlens 14 is larger than opening width of an opening 33 which will be described later. With this configuration, the amount of light received by each light receiving pixel 10 can be increased.

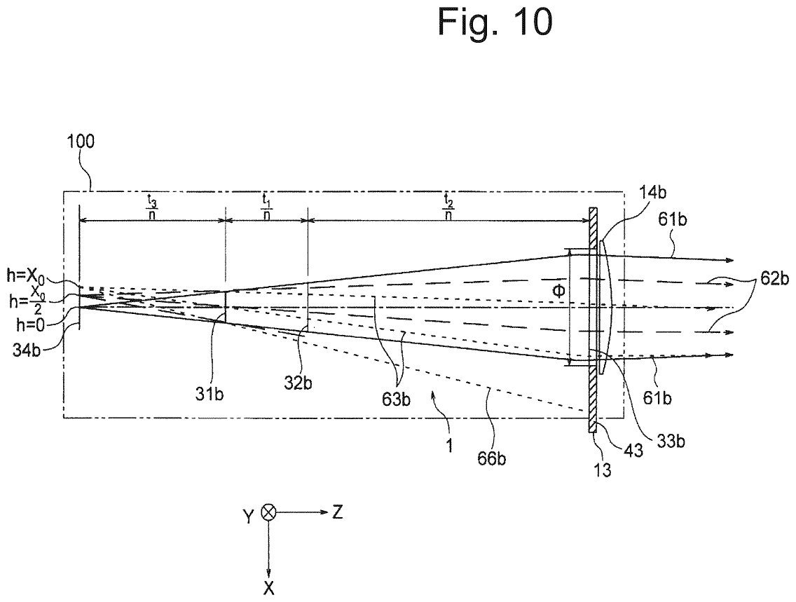

As shown in FIGS. 1 to 3, the imaging optical unit 1 further includes a light blocking member 13 as a fourth light blocking member. The light blocking member 13 is provided on the surface 52a of the glass member 52. The light blocking member 13 has a plurality of openings 33 as a plurality of fourth openings. The aforementioned plurality of microlenses 14 are arranged between the reference surface S and the plurality of openings 33. The openings 33 are formed by the same method as the above-described openings 31, 32 and 34. In FIG. 1, the opening 33 is in a circular shape. An opening area of the opening 33 is larger than each opening area of the openings 31 and 32. That is, a diameter (e.g., diameter Φ shown in FIG. 10 which will be explained later) as the opening width of the opening 33 is larger than each side of the openings 31 and 32. Further, the diameter of the opening 33 is smaller than the effective diameter of the microlens 14.

The diameter of the opening 33 is 100 μm, for example. The plurality of openings 33 are arranged at positions respectively corresponding to the plurality of light receiving pixels 10. In the first embodiment, the plurality of openings 33 respectively overlap with the plurality of light receiving pixels 10 as viewed in the Z-axis direction. The plurality of openings 33 are arrayed in two lines. The openings 33 in each line are arrayed in the X-axis direction. The plurality of openings 33 are arrayed in the hound's tooth pattern. Further, the plurality of openings 33 respectively overlap with the plurality of openings 31 and respectively overlap with the plurality of openings 32. Furthermore, the plurality of openings 33 are arranged at positions respectively corresponding to the plurality of microlenses 14. Specifically, on an XY plane, the central position of each of the plurality of openings 33 is the same as the central position of corresponding microlens 14.

As shown in FIG. 3, a part of the light blocking member 13 excluding the openings 33 is a light blocking part 43 that blocks the reflected light. The light blocking part 43 is a light blocking layer as a thin film formed on the glass member 52. Incidentally, a different configuration of the light blocking member 13 will be described later.

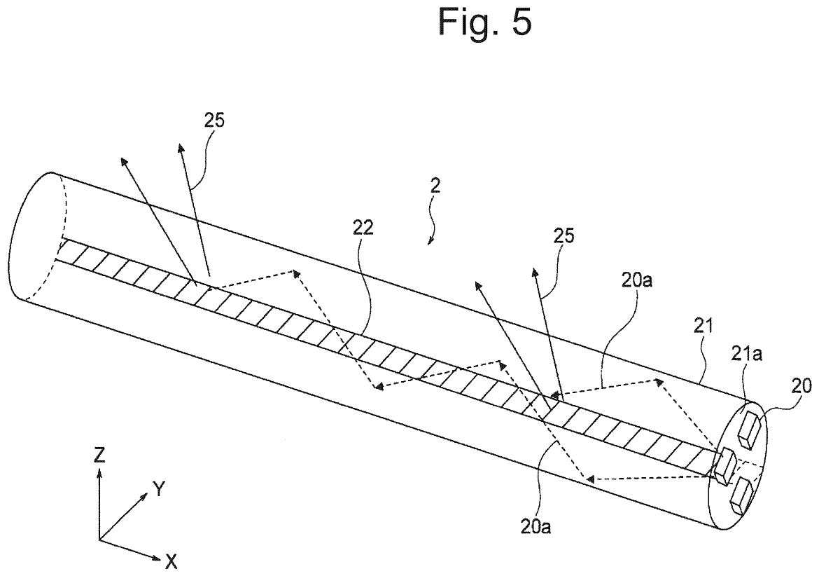

Next, the configuration of the illumination optical unit 2 will be described below. FIG. 5 is a diagram schematically showing the configuration of the illumination optical unit 2 shown in FIG. 1 and the illuminating light emitted from the illumination optical unit 2. As shown in FIGS. 2 and 5, the illumination optical unit 2 includes a light source 20 and a light guide member 21. The light source 20 is arranged at an end face 21a of the light guide member 21. The light source 20 emits light 20a to the inside of the light guide member 21. The light source 20 is a semiconductor light source, for example. The semiconductor light source is an LED (Light Emitting Diode) or the like, for example.

As shown in FIG. 5, the light guide member 21 directs the light 20a emitted from the light source 20 towards the document 6. The light guide member 21 is, for example, a cylindrical member formed of light-permeable resin material. The light 20a emitted from the light source 20 propagates while repeatedly undergoing total reflection inside the light guide member 21. A scattering region 22 is formed in a partial region of an internal side surface of the light guide member 21. The light 20a hitting the scattering region 22 is scattered and turns into scattered light. Then, part of the scattered light serves as the illuminating light 25 that illuminates the document 6.

The illuminating light 25 applied to the document 6 is reflected by the document 6 and turns into the reflected light. The reflected light successively passes through the microlenses 14, the openings 33, the glass member 52, the openings 32, the glass member 51, the openings 31, the glass member 53 and the openings 34 shown in FIG. 1 and enters the light receiving pixels 10.

### <Conditions for Acquiring an Image not Affected by Stray Light>

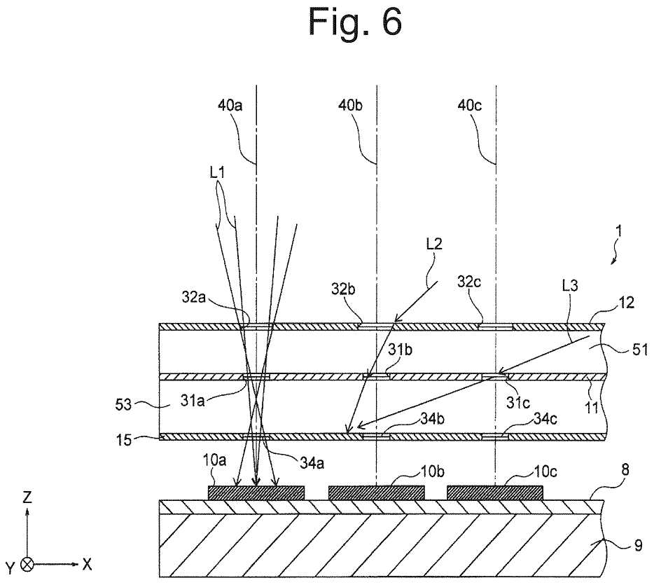

Next, conditions for the image reading device 100 for acquiring an image not affected by stray light will be described below by using FIG. 6. FIG. 6 is a diagram showing a part of the configuration of the image reading device 100 shown in FIG. 3 and the reflected light passing through the openings 32 and 31. Referring to FIG. 6, the conditions for acquiring an image not affected by the stray light traveling in the X-axis direction will be described below. Incidentally, in FIG. 6, a plurality of light receiving pixels 10 arrayed in the X-axis direction are represented also as light receiving pixels 10a, 10b and 10c. Similarly, a plurality of openings 31 are represented also as openings 31a, 31b and 31c, a plurality of openings 32 are represented also as openings 32a, 32b and 32c, and a plurality of openings 34 are represented also as openings 34a, 34b and 34c. Further, in the following description, a straight line connecting the center of an opening 32, the center of an opening 31, the center of an opening 34 and a light receiving pixel 10 is referred to as an optical axis 40a, 40b, 40c.

In FIG. 6, the reflected light from the document 6 (see FIG. 1) passing through the openings 32 and the openings 31 is indicated as rays L1, L2 and L3. The ray L1 passes through the opening 32a and the opening 31a and thereafter enters the light receiving pixel 10a via the opening 34a. As above, the light receiving pixel 10a has a sufficiently large area so that the whole of the ray passing through the three openings 32a, 31a and 34a aligned on the same optical axis 40a arrives at the light receiving pixel 10a. In this case, the opening 34a is a practical light receiving region of the light receiving pixel 10a.

The ray L2 is a ray that passes through the openings 32b and 31b situated on the optical axis 40b different from the optical axis 40a. The ray L3 is a ray that passes through the opening 31c situated on the optical axis 40c different from the optical axis 40a. The ray L2 and the ray L3 do not arrive at the light receiving pixel 10a. Therefore, the imaging optical unit 1 is capable of acquiring an image not affected by the stray light traveling in the X-axis direction. In the first embodiment, a ray passing through an opening 32 and an opening 31 situated on an optical axis of a light receiving pixel 10 enters the light receiving pixel 10 on the optical axis. Namely, the light receiving pixels 10 and the openings 31 are optically in a one-to-one correspondence and the light receiving pixels 10 and the openings 32 are optically in a one-to-one correspondence.

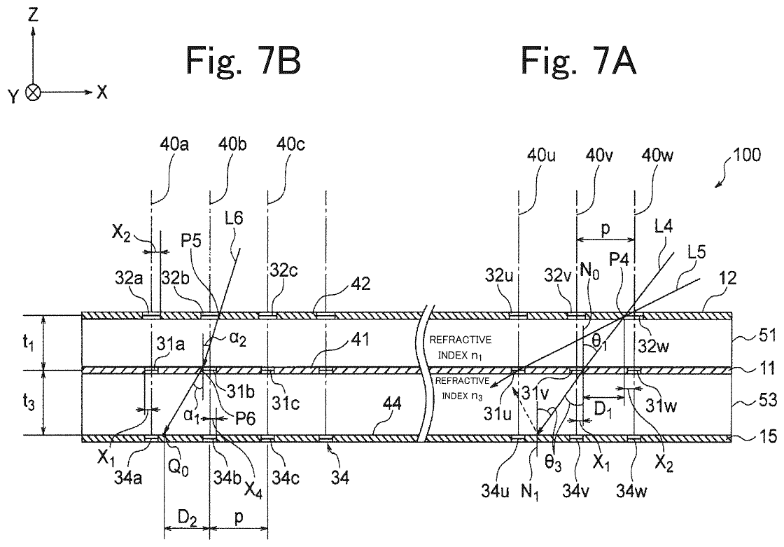

FIGS. 7A and 7B are diagrams for explaining conditions for the reflected light after passing through an opening 32 and an opening 31 corresponding to an opening 34 to pass through the opening 34 in the image reading device 100. In FIGS. 7A and 78, the thickness of the glass member 51 is represented as a thickness t₁, the thickness of the glass member 53 is represented as a thickness t₃, the refractive index of the glass member 51 is represented as a refractive index n₁, and the refractive index of the glass member 53 is represented as a refractive index n₃. When the following conditions 1 and 2 are both satisfied, only the reflected light after passing through the opening 32 and the opening 31 passes through the opening 34 as the practical light receiving region of the light receiving pixel 10.

### (Condition 1)

Among rays passing through an opening 32 and an opening 31 having optical axes different from each other, there exists no ray that passes through an opening 34.

### (Condition 2)

A ray that passed through an opening 32 and an opening 31 having the same optical axis does not arrive at an opening 34 other than the opening 34 on the same optical axis.

The condition 1 and the condition 2 will be explained below by using FIGS. 7A and 7B.

For the condition 1, a sufficient condition is that the smallest incidence angle 91 of a ray at an opening 32, among the incidence angles of the rays passing through an opening 32 and an opening 31 having optical axes different from each other, satisfies the following expression (1):

n₁·sin θ₁>1 (1)

The reason why satisfying the expression (1) is a sufficient condition for the condition 1 will be explained below. In FIG. 7A, the ray having the incidence angle θ₁ is represented as a ray L4. The ray L4 is a ray that passes through a left end point P4 in an opening 32w and a right end point in an opening 31v. Let θ₃ represent an emission angle of the ray L4 when entering the glass member 53, the incidence angle θ₁ and the emission angle θ₃ satisfy the following expression (2) according to the Snell's law:

n₁·sin θ₁=n₃·sin θ₃ (2)

An incidence angle of the ray L4 when being incident upon a surface of the glass member 53 on the −Z-axis side is the angle θ₃. When an incidence position of the ray L4 in this case is on the light blocking member 15, the ray L4 is blocked irrespective of the incidence angle and thus does not pass through the opening 34. In contrast, when the incidence position of the ray L4 is in the opening 34, the following expression (3) is derived from the expression (1) and the expression (2):

n₃·sin θ₃>1 (3)

The expression (3) indicates that the ray L4 whose incidence angle is θ₃ undergoes total reflection at the opening 34, and thus the ray L4 does not pass through the opening 34. Even supposing that the incidence angle of the ray L4 entering the opening 32 is larger than the incidence angle θ₁, the expression (1) is satisfied and thus the ray L4 undergoes total reflection at the opening 34 even if the ray L4 arrives at the opening 34. Thus, even in this case, the ray L4 does not pass through the opening 34. Accordingly, satisfying the expression (1) is a sufficient condition for the condition 1.

Next, the condition of the expression (1) will be expressed below by using parameters of the thickness and the opening width of the glass member 51. Opening half widths as ½ of the opening widths of the opening 31, the opening 32 and the opening 34 in the X-axis direction are respectively represented as X₁, X₂ and X₄. A distance D₁ in the X-axis direction between a −X-axis direction end of the opening 32w and a +X-axis direction end of the opening 31v is obtained according to the following expression (4):

D₁=p−X₁−X₂ (4)

As is clear from FIG. 7A, a relationship of the following expression (5) is satisfied in regard to the incidence angle θ₁ of the ray L4:

tan θ₁=D₁/t₁=(p−X₁−X₂)/t₁ (5)

From the expression (1) and the expression (5), the following expression (6) is derived in regard to the thickness t₁ of the glass member 51 satisfying the aforementioned condition 1:

t₁<\sqrt{n₁²−1}·(p−X₁−X₂) (6)

Namely, the ray L4 satisfies the total reflection condition if the thickness t₁ of the glass member 51 is less than the value on the right side of the expression (6). In this case, the aforementioned condition 1 is satisfied.

Next, the aforementioned condition 2 will be explained below by using FIG. 7B. The following explanation will be given by using one opening 34b among the plurality of openings 34 and openings 34a and 34c adjoining the opening 34b an both sides in the X-axis direction, for example. The aforementioned condition 2 is satisfied when a ray L6 passing through a point P5 in the opening 32b overlapping with the opening 34b and a point P6 in the opening 31b overlapping with the opening 34b arrives at a region between the opening 34a and the opening 34c and enters neither of the opening 34a and the opening 34c. The region between the opening 34a and the opening 34c is a region sandwiched between the right end of the opening 34a and the left end of the opening 34c shown in FIG. 7B.

The ray L6 shown in FIG. 7B is a ray that passes through the opening 32b and the opening 31b overlapping with the opening 32b. In FIG. 7B, the ray L6 passes through an end part of the opening 32b closest to the opening 32c and thereafter passes through an end part of the opening 31b closest to the opening 31a. The ray L6 that passed through the opening 31b arrives at a point Q₀. Here, the point Q₀ represents a point in a region between the opening 34a and the opening 34b at which the ray L6 arrived. In FIG. 7B, the point Q₀ represents a point that is the farthest from the opening 34b in the −X-axis direction, that is, a point that is the closest to the opening 34a. As above, when the ray L6 arrives at the point Q₀ as a point on the opening 34b's side relative to an end of the opening 34a closest to the opening 34b, the ray that passed through the opening 32b and the opening 31b does not arrive at an opening (e.g., the opening 34a or the opening 34c) other than the opening 34b.

Here, let α₁ represent the emission angle of the ray L6 and α₂ represent the incidence angle of the ray L6, the incidence angle α₂ is obtained by using the following expression (7):

tan α₂=(X₁+X₂)/t₁ (7)

Further, according to the Snell's law, the relationship between the emission angle α₁ and the incidence angle α₂ is represented by the following expression (8):

n₁·sin α₂=n₃·sin α₁ (8)

Furthermore, the distance D₂ from the optical axis 40b to the point Q₀ is obtained by using the following expression (9):

D₂=X₁+t₃·tan α₁ (9)

Here, the condition that the point Q₀ is situated on the opening 34b's side relative to the end of the opening 34a in the +X-axis direction is represented by the following expression (10):

p−X₄>X₁+t₃·tan α₁ (10)

From the expressions (7) to (10), the following expression (11) is derived in regard to the thickness t₁ of the glass member 51 satisfying the aforementioned condition 2:

$${t}_{1} > ( {X}_{1} + {X}_{2} ) \cdot \sqrt{{( \frac{{n}_{1}}{{n}_{3}} )}^{2} - 1 + \frac{{( {n}_{1} / {n}_{3} )}^{2} \cdot {{t}_{3}}^{2}}{{( p - {X}_{1} - {X}_{3} )}^{2}}} \qquad ( 11 )$$

Namely, the aforementioned condition 2 is satisfied when the thickness t₁ of the glass member 51 is greater than the value on the right side of the expression (11). Incidentally, since the refractive index n₁ of the glass member 51 and the refractive index n₂ of the glass member 53 are equal to each other in the first embodiment, the expression (11) is represented by the following expression (12):

t₁>t₃·(X₁+X₂)/(p−X₁−X₀) (12)

In an example in the first embodiment, X₁=20 μm, X₂=40 μm, X₄=20 μm, t₃=210 μm, p=250 μm, and n₁=1.52. With these values substituted into the right sides of the expression (6) and the expression (12), the right sides of the expressions respectively take on values of 217 μm and 60 μm. Thus, t₁=210 μm satisfies both of the expression (6) and the expression (12).

Next, the array of the plurality of light receiving pixels 10 will be explained below by using FIG. 4. The plurality of light receiving pixels 10 are arrayed in a plurality of rows and a plurality of columns (lines). Further, in FIG. 4, the plurality of light receiving pixels 10 are arrayed in the hound's tooth pattern. Suppose that resolution equal to that of the image reading device 100 according to the first embodiment is obtained in an image reading device in which the plurality of light receiving pixels are arrayed in one line, an array pitch of the light receiving pixels in the main scanning direction (i.e., the X-axis direction) is a half value (i.e., 125 μm) of the array pitch of the light receiving pixels 10 in the first embodiment. In other words, the array pitch of the light receiving pixels 10 arrayed in the same line can be set long in the image reading device 100 according to the first embodiment.

In contrast, in the image reading device in which the plurality of light receiving pixels are arrayed in one line, it is difficult to obtain the thickness t₁ satisfying both of the aforementioned expressions (6) and (12) while maintaining the opening half widths of the openings at great values. Incidentally, even in the case where the plurality of light receiving pixels are arrayed in one line, there exists the thickness t₁ as a parameter satisfying both of the expression (6) and the expression (12). Therefore, the above explanations (e.g., the explanations regarding the aforementioned conditions 1 and 2), excluding the explanations regarding the configuration in which the plurality of light receiving pixels 10 are arrayed in two lines, are applied also to the case where the plurality of light receiving pixels are arrayed in one line.

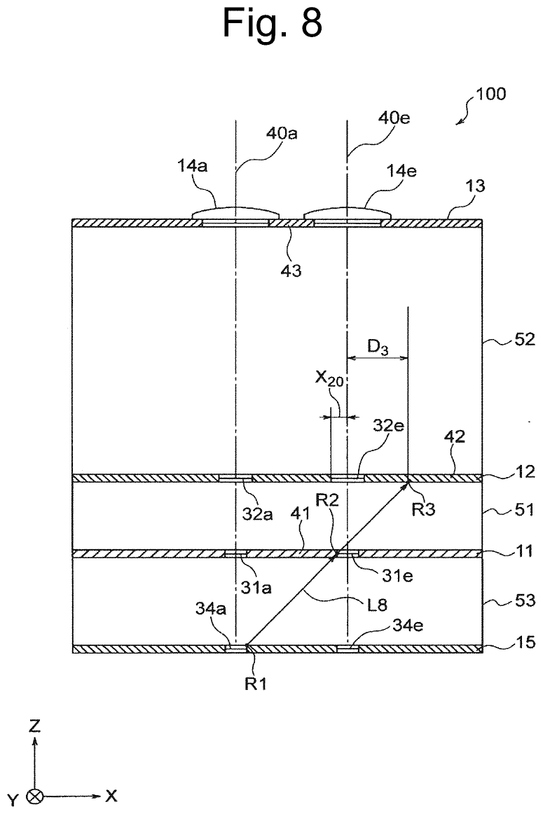

Next, a description will be given of conditions for a ray after passing through an opening 32 and an opening 31 arranged at positions overlapping with a light receiving pixel 10 belonging to one line included in the two lines of light receiving pixels 10 for not entering a light receiving pixel 10 belonging to the other line in the image reading device 100. FIG. 8 is a cross-sectional view of the image reading device 100 shown in FIG. 1 taken along the line A8-A8. Specifically, FIG. 8 is a cross-sectional view at a plane including points P1 and P2 shown in FIG. 1. Incidentally, in the following description, the openings 34 arrayed in the first line 10u (see FIG. 4) will be represented also as openings 34a, and the openings 34 arrayed in the second line 10v (see FIG. 4) will be represented also as openings 34e. The first and second openings 31 and 32 overlapping with the opening 34a will be represented also as openings 31a and 32a, and the first and second openings 31 and 32 overlapping with the opening 34e will be represented also as openings 31e and 32e. The microlens 14 overlapping with the opening 32a will be represented also as a microlens 14a, and the microlens 14 overlapping with the opening 32e will be represented also as a microlens 14e. Further, the optical axis of the microlens 14a is represented by a reference character 40a, and the optical axis of the microlens 14e is represented by a reference character 40e.

The following description will be given of the conditions for a ray after passing through an opening 32e and an opening 31e for not entering an opening 34a. This description will be given by using an inverse ray L8 as a virtual ray heading from the opening 34a towards the opening 31e as shown in FIG. 8. The inverse ray L8 is a ray that travels from a point R1, passes through a point R2, and arrives at a point R3. The point R1 is an end of the opening 34a closest to the opening 34e. The point R2 is at end of the opening 31e closest to the opening 31a. The point R3 is a point situated on an outer side relative to an end of the opening 32e farthest from the opening 32a. If the inverse ray L8 arrives at the light blocking part 41 or the light blocking part 42, the ray after passing through the opening 32e and the opening 31e does not enter the opening 34a. Referring to FIG. 8, the description will be given by taking an example of a case where the inverse ray L8 arrives at the light blocking part 42.

In FIG. 8, the distance between the point R3 and the optical axis 40e is represented as D₃, and a length as ½ of the length of a diagonal line of the opening 32e in the square shape is represented as X₂₀. If the distance D₃ is greater than the length X₂₀, the inverse ray L8 arrives at the light blocking part 42. Accordingly, the ray after passing through the opening 32e and the opening 31e does not enter the opening 34a. Even supposing that the distance is less than the length X₂₀ and the inverse ray L8 passes through the opening 32e, if the interval q shown in FIG. 4 is long, the inverse ray L8 arrives at the light blocking part 43 of the light blocking member 13. Thus, even when the distance D₃ is less than the length X₂₀, the ray after passing through the opening 32e and the opening 31e does not enter the opening 34a since the interval q is long and the image reading device 100 includes the light blocking member 13.

### <Restoration of Image>

Next, a description will be given of a method for the imaging optical unit 1 for restoring the image of the document 6 based on image information acquired from the light receiving pixels 10. In the first embodiment, the plurality of light receiving pixels 10 are arrayed in the hound's tooth pattern as shown in FIG. 4, and thus the central position of the light receiving pixels 10 belonging to the first line 10u and the central position of the light receiving pixels 10 belonging to the second line 10v are deviated (displaced) from each other in the Y-axis direction by the distance q. Therefore, when the document 6 has been scanned in the Y-axis direction, the image of the document 6 has to be restored to an image with no displacement. Specifically, an image processing circuit (not shown) after acquiring image information from the light receiving pixels 10 in the first line 10u and image information from the light receiving pixels 10 in the second line 10v may execute a process of shifting the image information in the Y-axis direction by a certain number of pixels corresponding to the distance q.

In FIG. 4, the light receiving pixels 10 in the second line 10v are arranged to deviate in the X-axis direction relative to the light receiving pixels 10 in the first line 10u by the distance p/2 as ½ of the distance p. The image processing circuit acquires outputs from the light receiving pixels 10 at a time interval for conveying the document 6 in the Y-axis direction by the distance p/2. Incidentally, in the first embodiment, the resolution in the X-axis direction and the resolution in the Y-axis direction are at the same value. While the distance q representing the displacement amount of the image information is desired to be an integral multiple of the distance p/2, the distance q is not limited to an integral multiple of the distance p/2. It is also possible for the image processing circuit to estimate luminance values at subpixel positions by using a pixel complementing process and synthesize image information by using the estimated luminance values. Further, it is also possible for the image processing circuit to shift the timing for the light receiving pixels 10 belonging to the first line 10u to obtain image information and the timing for the light receiving pixels 10 belonging to the second line 10v to obtain image information from each other and combine the obtained pieces of image information together.

### <Depth of Field>

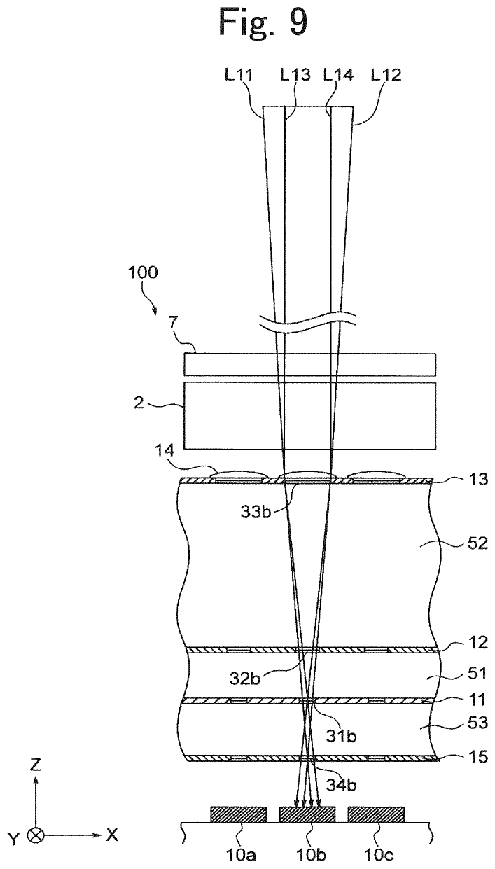

Next, the depth of field of the image reading device 100 according to the first embodiment will be described below. FIG. 9 is a diagram schematically showing a pencil of rays of reflected light L11-L14 entering the light receiving pixel 10b shown in FIG. 3. As shown in FIG. 9, in the image reading device 100, the microlenses 14 are arranged apart from the light blocking member 12 in the +Z-axis direction. Specifically, the microlenses 14 are arranged sufficiently apart from the light blocking member 12 across the glass member 52 and the light blocking member 13.

FIG. 10 is a diagram showing virtual inverse rays 61b, 62b, 63b and 66b heading in the +Z-axis direction from the opening 34b in the image reading device 100 according to the first embodiment. The inverse ray 61b is an inverse ray heading in the +Z-axis direction from a point on an object surface where an image height h=0. The inverse ray 62b is an inverse ray heading in the +Z-axis direction from a point on the object surface where the image height h=X₀/2. The inverse ray 63b is an inverse ray heading in the +Z-axis direction from a point on the object surface where the image height h=X₀. The inverse ray 66b, which is an inverse ray heading in the +Z-axis direction from the point where the image height h=X₀ similarly to the inverse ray 63b, is blocked by the light blocking member 13. In FIG. 10, for convenience of the explanation, each glass member having a refractive index n and a thickness t is shown while being replaced with a distance after conversion into air having a refractive index 1 and a thickness t/n. As shown in FIG. 10, the microlens 14 is arranged at a distance of t₂/n from the opening 32b of the light blocking member 12.

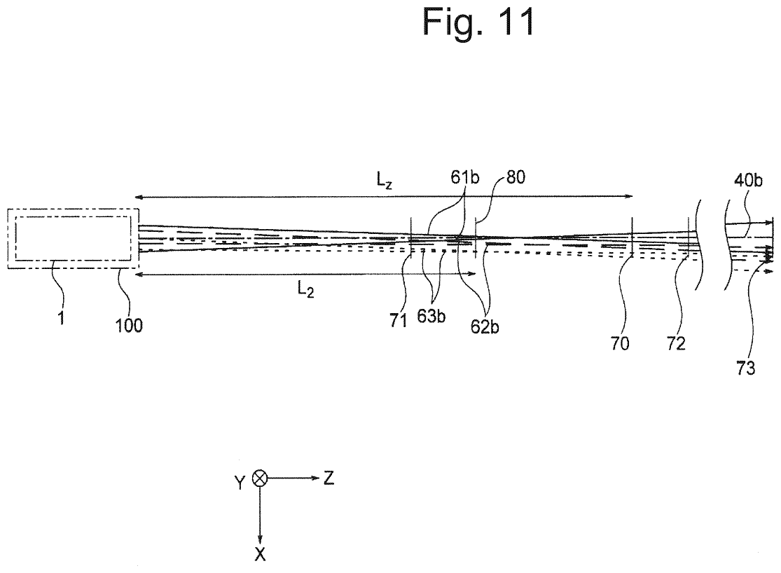

FIG. 11 is a diagram showing broadening of the inverse rays 61b, 62b and 63b shown in FIG. 10. In FIG. 11, the imaging optical unit 1 shown in FIG. 10 is reduced in order to emphasize the broadening of the inverse rays 61b, 62b and 63b. In the image reading device 100, the focal distance of the microlens 14b has been set so that a point on the opening 34b has its focal point at a point (e.g., a position that is 3.0 mm in the +Z-axis direction from the imaging optical unit 1) situated between a target 71 and a target 72. As shown in FIGS. 10 and 11, principal rays of the pencils of rays of the inverse rays 61b, 62b and 63b after passing through the microlens 14b have become substantially parallel to the Z-axis direction. Here, the principal ray is a ray passing through the center of the pencil of rays.

In FIG. 11, a position where the broadening of the pencil of rays of the inverse rays 61b, 62b and 63b becomes a range corresponding to two pixels on the document 6 (shown in FIG. 1) is represented as a position 70. Further, the distance from the imaging optical unit 1 to the position 70 is represented as L_{z}. Furthermore, in FIG. 11, a plane parallel to the XY plane and including a point where the inverse rays 61b and 63b are condensed is represented as a plane 80, and the distance from the microlens 14b to the plane 80 is represented as L₂.

In the image reading device 100, the distance L₂ is 3.5 mm, for example. Accordingly, in the image reading device 100, a sufficiently great depth of field can be secured even if the top glass plate 7 and the illumination optical unit 2 are arranged between the opening 32b and the reference surface 5. For example, when a space of 1.5 mm is necessary to arrange the top glass plate 7 and the illumination optical unit 2, a 2.0 mm depth of field can be obtained. Accordingly, the depth of field becomes great since the microlens 14b is arranged apart from the opening 32 in the image reading device 100. Further, in the image reading device 100, the depth of field can be expanded even when the half width X₀ of the light receiving pixel 10, the opening half width X₁ of the opening 31 and the opening halt width X₂ of the opening 32 are set large. Therefore, in the image reading device 100, the depth of field can be expanded while increasing the light amount of the reflected light passing through each opening 34, namely, the amount of light received by each light receiving pixel 10.

### <Position of Focal Point of Condensing Lens>

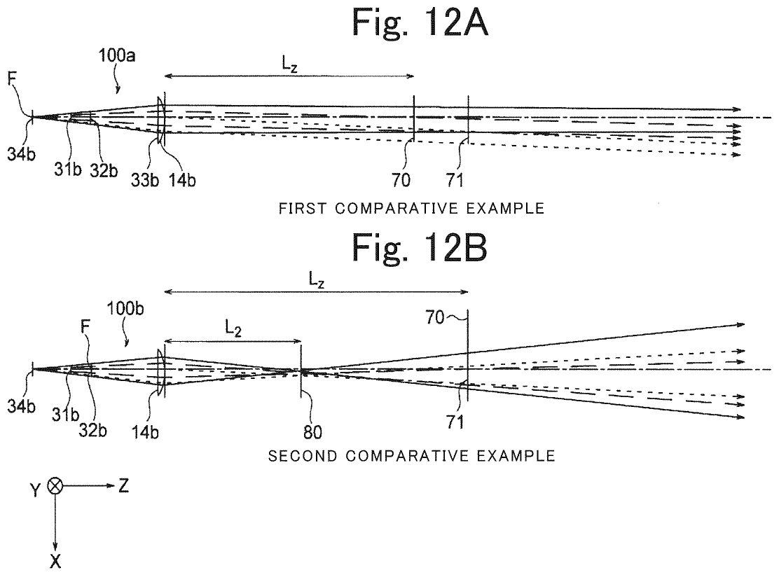

Next, the position of a focal point F of the microlens 14 (i.e., a position where a focus is formed when parallel rays are incident from the document 6's side) necessary for reducing the broadening of the inverse rays will be described below by using a result of tracking the inverse rays. FIG. 12A is a diagram showing virtual inverse rays heading in the +Z-axis direction from the opening 34b in an image reading device 100a according to a first comparative example.

As shown in FIG. 12A, in the first comparative example, the position of the focal point of the microlens 14b in the Z-axis direction overlaps with the position of the opening 34b in the Z-axis direction. In this case, inverse rays emitted from one point on the opening 34b pass through the microlens 14b and thereafter turn into parallel rays having the same width as an opening region of an opening 33b. Since the opening 34b has a certain area, the principal ray of a pencil of rays emitted in the inverse direction from a point on the opening 34b deviated from its optical axis passes through the microlens 14b and thereafter travels in a direction to gradually separate from the optical axis. Therefore, with the increase in the distance from the microlens 14b, the width of the inverse rays emitted from the whole of the opening 34b increases. That is, the depth of field is small in the first comparative example since the distance L_{z} representing the distance from the microlens 14 to the plane 70 is small.

FIG. 12B is a diagram showing virtual inverse rays heading in the +Z-axis direction from the opening 34b in an image reading device 100b according to a second comparative example. In the second comparative example, the position of the focal point F of the microlens 14b in the Z-axis direction overlaps with the position of the opening 32b in the Z-axis direction. In the second comparative example, condensing power of the microlens 14b is stronger and the position 80 where the inverse rays are condensed is closer to the microlens 14b. Thus, in the second comparative example, the broadening of the inverse rays after passing through the plane 90 is greater and the distance L_{z} is small. Accordingly, the depth of field of the image reading device 100b according to the second comparative example is small similarly to the depth of field of the image reading device 100a according to the first comparative example.

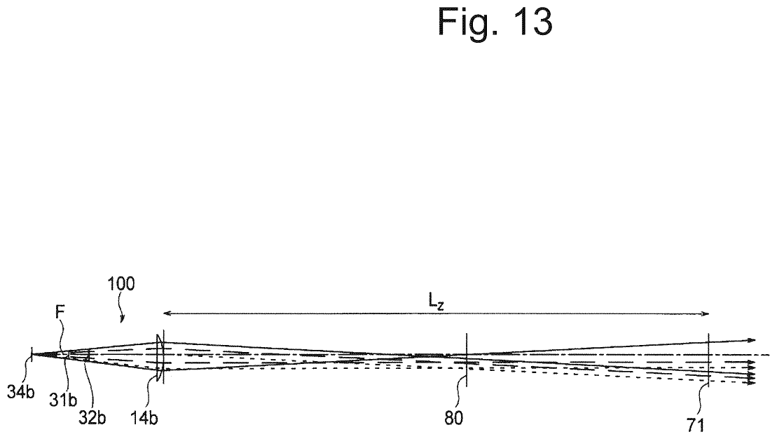

FIG. 13 is a diagram showing virtual inverse rays heading in the +Z-axis direction from the opening 34b in the image reading device 100 according to the first embodiment. In the image reading device 100, the position of the focal point F of the microlens 14b in the Z-axis direction is situated between the opening 34b and the opening 31b. In the image reading device 100, the distance L_{z} is greater compared to the first and second comparative examples and the depth of field can be expanded. As above, by setting the position of the focal point F of the microlens 14b between the opening 34b and the opening 32b, the broadening of the inverse rays can be reduced and the depth of field of the image reading device 100 can be expanded. The range between the opening 34b and the opening 32b is a region sandwiched between the light blocking member 12's surface on the −Z-axis direction side and the light blocking member 15's surface on the +Z-axis direction side shown in FIG. 2.

### <Different Configuration of Light Blocking Member 13>

Next, a different configuration of the light blocking member 13 will be described below by using FIGS. 1, 2, 3 and 10. The opening width (i.e., diameter) of the opening 33 of the light blocking member 13 is smaller than the effective diameter of the microlens 14. Therefore, the inverse ray 66b shown in FIG. 10 arrives at the light blocking member 13. Here, since the inverse ray 66b is an inverse ray heading in the +Z-axis direction from an end of the opening 34b in the X-axis direction, all of the rays entering the opening 34b have passed through the opening 33b. Namely, when reflected and scattered light generated on the document 6 arrives at a position outside the microlens 14, the light is blocked by the light blocking member 13 and thus does not arrive at the opening 34b. Accordingly, deterioration in the contrast of the image or occurrence of a ghost image is prevented in the image reading device 100, and thus the image reading device 100 is capable of reading out an image having excellent image quality.

### <Relationship Between Temperature Change and Amount of Light Received by Light Receiving Pixel>

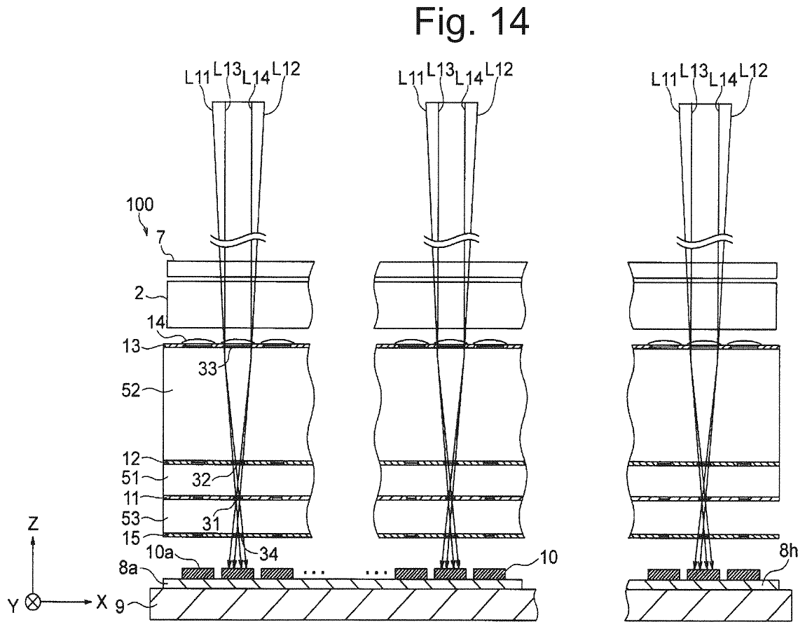

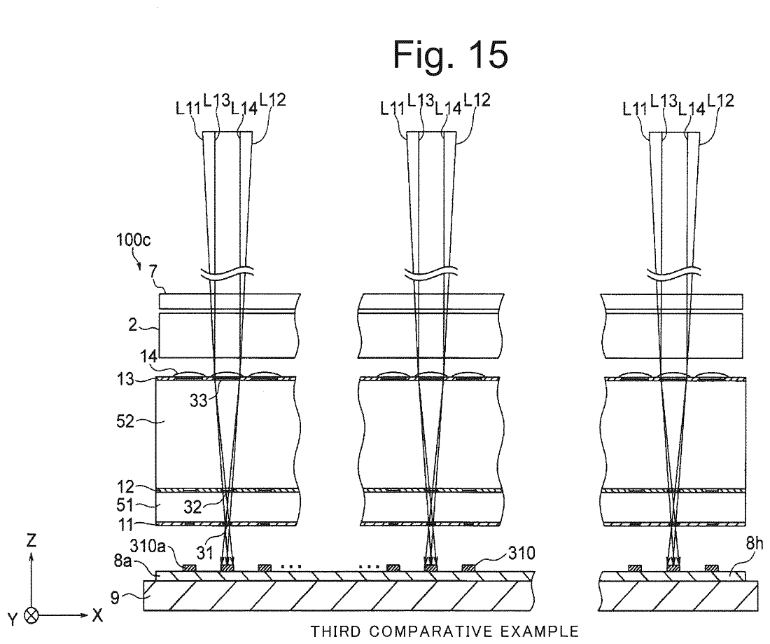

Next, the relationship between the temperature change and the amount of light received by the light receiving pixel will be described below in contrast with a third comparative example by using FIGS. 14 and 15. FIG. 14 is a diagram showing a part of the configuration of the image reading device 100 shown in FIG. 3 and the reflected light L11-L14 entering the light receiving pixel 10. FIG. 15 is a diagram showing a part of a configuration of an image reading device 100c according to the third comparative example and the reflected light L11-L14 entering a light receiving pixel 310. The image reading device 100c differs from the image reading device 100 according to the first embodiment in that the image reading device 100c does not include the glass member 53 or the light blocking member 15. Therefore, in the image reading device 100c, the reflected light after passing through the opening 31 directly enters the light receiving pixel 310. Thus, in the image reading device 100c, the light receiving region of the light receiving pixel 310 receives a pencil of rays of the reflected light L11-L14 that passed through the opening 31.

While a pencil of rays of the reflected light L11-L14 enters each of the plurality of light receiving pixels 10, 310, pencils of rays of the reflected light L11-L14 entering some of the plurality of light receiving pixels 10 are shown in FIGS. 14 and 15 in order to facilitate the understanding of the description. In FIG. 14, the opening 34 is in a square shape of 35 μm×35 μm and the size of one light receiving pixel 10 is 200 μm×200 μm. In FIG. 15, the size of one light receiving pixel 310 is 35 μm×35 μm, for example.

On one sensor chip 8 shown in FIGS. 14 and 15, one hundred light receiving pixels 10, 310 are arrayed in the X-axis direction, for example. Therefore, when the array pitch of the light receiving pixels 10, 310 (e.g., the pitch p/2 shown in FIG. 4) is 125 μm, an imaging range captured by one sensor chip 8 is 12.5 mm. Thus, to obtain a scan width of 100 mm, it is sufficient if eight sensor chips 8 are arrayed in the X-axis direction in the image reading device 100, 100c. In FIGS. 14 and 15, a sensor chip situated farthest in the −X-axis direction is represented as 8a, and a sensor chip situated farthest in the +X-axis direction is represented as 8h. Further, in each of FIGS. 14 and 15, a light receiving pixel that is separate from an X-axis direction central position of the sensor substrate 9 in the −X-axis direction by 50 mm is represented as a light receiving pixel 10a, 310a.

As described earlier, the sensor chip 8 is formed from silicon material and the sensor substrate 9 is formed from glass epoxy resin. Further, the glass members (the glass members 51 to 53 in FIG. 14, the glass members 51 and 52 in FIG. 15) are formed from glass material. Therefore, linear expansion coefficients of the sensor chip 8, the sensor substrate 9 and the glass members differ from each other. Thus, when a temperature change amount grows greater than 0° C., the optical axis of the microlens 14 deviates from the central position of the light receiving pixel 10, 310. Here, the temperature change amount is a temperature difference between a first temperature as the temperature at a predetermined first time point and a second temperature as the temperature at a second time point after the elapse of a predetermined time from the first time point.

In the image reading device 100c, the openings 31 to 33 are situated on the optical axis 40 of the microlens 14. Thus, when the optical axis of the microlens 14 deviates, relative positional displacement (i.e., a positional error) occurs to the central position of each of the openings 31 to 33 in regard to the relationship with the central position of the light receiving pixel 310. In the image reading device 100, when the optical axis of the microlens 14 deviates, a positional error occurs to the central position of each of the openings 31 to 34 in regard to the relationship with the central position of the light receiving pixel 10.

Here, the sensor substrate 9 and the glass members 51 to 53 have been bonded together at a central position of the X-axis direction width (position where the X coordinate X satisfies X_{c}=0), and the sensor substrate 9 and the glass members 51 to 53 expand or contract in the X-axis direction due to a temperature change. When the temperature change amount grows greater than 0° C., the position of the light receiving pixel 10, 310 in the X-axis direction changes due to thermal expansion of the sensor chip and thermal expansion of the sensor substrate 9. Here, since a plurality of sensor chips are arrayed away from each other in the X-axis direction on the sensor substrate 9, the displacement of the light receiving pixel 10, 310 in the X-axis direction due to the temperature change is influenced more by the thermal expansion of the sensor substrate 9 than by the thermal expansion of the sensor chip.

Here, the linear expansion coefficient of glass epoxy resin as the material of the sensor substrate 9 is 3×10⁻/° C., for example. The X coordinate X₁₀ of each light receiving pixel 10a, 310a is X₁₀=−50 with reference to the central position of the X-axis direction width of the sensor substrate 9 as a fixed point (i.e., the position where X_{c}=0). Namely, the light receiving pixel 10a, 310a is separate from the X-axis direction central position of the sensor substrate 9 by −50 mm. Therefore, the displacement amount ΔX₁ of each light receiving pixel 10a, 310a when the temperature change amount ΔT is −40° C. is 60 μm, for example.

The linear expansion coefficient of glass material as the material of the glass members 51, 52 and 53 is 7×10⁻⁶/C, for example. When the temperature change amount ΔT is −40° C., for example, the displacement amount ΔX₂ of the opening 31 situated on the same optical axis as the light receiving pixel 10a, 310a is 14 μm. Here, a relative displacement amount ΔX₃ of the light receiving pixel 10a, 310a and the opening 31 is represented by the following expression (13):

ΔX₃=ΔX₁−ΔX₂ (13)

Thus, when the displacement amount ΔX₁ is 60 μm and the displacement amount ΔX₂ is 14 μm, the relative displacement amount ΔX₃ when the temperature change amount ΔT is −40° C. is 46 μm.

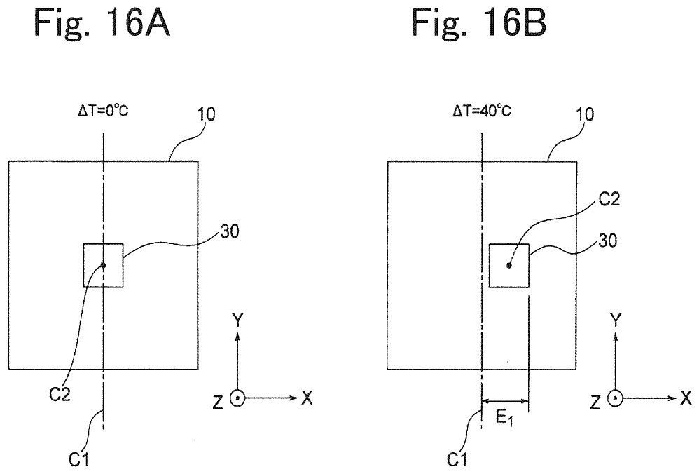

FIG. 16A is a diagram showing the relationship between the light receiving pixel 10 shown in FIG. 14 and an irradiation region 30 of the reflected light entering the light receiving pixel 10 when the temperature change amount ΔT is 0° C. As shown in FIG. 16A, when the temperature change amount ΔT is 0° C., the center C2 of the irradiation region 30 of the reflected light is situated on a center line C1 passing through the center of the light receiving pixel 10 in the X-axis direction and extending in the Y-axis direction. Here, the size of the irradiation region 30 is slightly larger than the opening 34 since angular distribution of the reflected light entering the opening 34 has a certain amount of broadening. The size of the irradiation region 30 is 60 μm×60 μm, for example.

FIG. 16B is a diagram showing the relationship between the light receiving pixel 10 shown in FIG. 14 and the irradiation region 30 of the reflected light entering the light receiving pixel 10 when the temperature change amount ΔT is 40° C. As shown in FIG. 16B, when the temperature change amount ΔT is 40° C., the center C2 of the irradiation region 30 is deviated to the +X-axis side from the center line C1 of the light receiving pixel 10.

Let E₁ represent the distance between the center line C1 of the light receiving pixel 10 and a +X-axis direction end of the irradiation region 30, the distance E₁ is a value obtained by adding the aforementioned relative displacement amount ΔX₃ (46 μm in the first embodiment) to a ½ value of the X-axis direction width of the irradiation region 30 (30 μm in the first embodiment). Thus, in FIG. 16B, the distance E₁ is 76 μm. Since this distance E₁ is smaller than a ½ value of the X-axis direction width of the light receiving pixel 10 (100 μm in the first embodiment), the irradiation region 30 is included in the light receiving region of the light receiving pixel 10 even when the temperature change amount ΔT is 40° C. in the first embodiment. Therefore, in the image reading device 100, the decrease in the amount of light received by each light receiving pixel 10 can be prevented even when a temperature change has occurred to the sensor substrate 9 and the glass members 51 to 53. Namely, the change in the amount of light received by each light receiving pixel 10 is small even when a temperature change has occurred.

As above, in the image reading device 100, the light receiving region of the light receiving pixel 10 is sufficiently larger than the opening area of the opening 34. Specifically, the X-axis direction width of the light receiving pixel 10 is sufficiently larger than the X-axis direction opening width of the opening 34. Therefore, even when the displacement of the center C2 of the irradiation region 30 from the center line C1 of the light receiving pixel. 10 due to a temperature change has occurred, the irradiation region 30 is included in the light receiving region of the light receiving pixel 10. Here, with the decrease in the spacing to between the opening 34 and the light receiving pixel 10 (see FIG. 3), the size of the irradiation region 30 becomes closer to the size of the opening 34. In the example shown in the first embodiment, the spacing to between the light receiving pixel 10 and the glass member 53 is 250 μm and is sufficiently small, and thus the size of the irradiation region 30 can be approximately considered to be equal to the size of the opening 34.

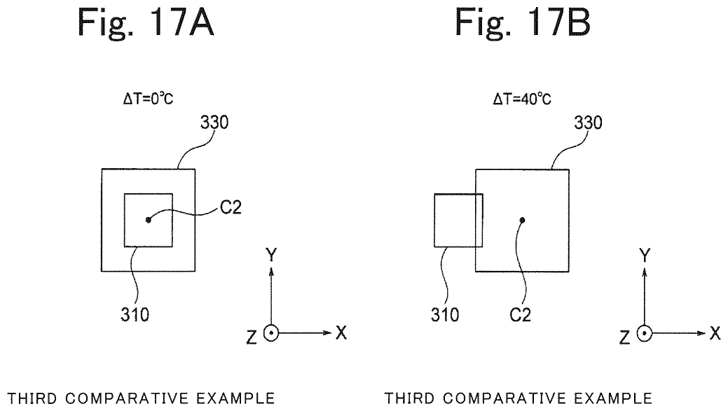

FIG. 17A is a diagram showing the relationship between the light receiving pixel 310 shown in FIG. 15 and an irradiation region 330 of the reflected light entering the light receiving pixel 310 when the temperature change amount ΔT is 0° C. As shown in FIG. 17A, when the temperature change amount ΔT is 0° C., the irradiation region 330 is larger than the light receiving region of the light receiving pixel 310. This is because no openings 34 are arranged between the light blocking member 11 and the light receiving pixel 310 in the image reading device 100c. Further, in FIG. 17A, the center C2 of the irradiation region 330 coincides with the X-axis direction center of the light receiving pixel 10.

FIG. 17B is a diagram showing the relationship between the light receiving pixel 310 shown in FIG. 15 and the irradiation region 330 of the reflected light; entering the light receiving pixel 310 when the temperature change amount ΔT is 40° C. In the image reading device 100c, the size of the light receiving pixel 310a is 35 μm×35 μm as mentioned earlier, and thus the aforementioned relative displacement amount ΔX₃ is larger than 35 μm as the X-axis direction width of the light receiving pixel 310a. Thus, when the temperature change amount ΔT is 40° C., the center C2 of the irradiation region 330 is greatly deviated to the +X-axis side from the light receiving region of the light receiving pixel 310 as shown in FIG. 17B. In this case, in the image reading device 100c, part of the reflected light traveling towards the light receiving pixel 310a deviates from the light receiving region due to the temperature change of the sensor substrate 9 and the glass members 51 and 52, by which the amount of light received by the light receiving pixel 310 decreases or no reflected light enters the light receiving pixel 310. Incidentally, even supposing that the temperature change amount ΔT is less than 40° C., the amount of light received by the light receiving pixel 310 decreases due to the displacement of the irradiation region 330 with respect to the light receiving pixel 310 since illuminance distribution in the irradiation region 330 is not uniform.

Since the number of component members of the image reading device 100c is smaller than the number of component members of the image reading device 100, the configuration of the image reading device 100c is simpler than the configuration of the image reading device 100. However, in the image reading device 100c, the amount of light received by the light receiving pixel 310 decreases due to the temperature change of the sensor substrate 9 and the glass members 51 and 52 as described above. Incidentally, in cases where the temperature condition and the assembly work of the image reading device 100c are ideal, the image reading device 100c is capable of preventing the decrease in the amount of light received by each light receiving pixel 310 similarly to the image reading device 100.

Next, a description will be given of a fact that a permissible range of an assembly error of the imaging optical unit. 1 is wide in the image reading device 100. An assembly process of the imaging optical unit 1 of the image reading device 100 is as described below. First, a plurality of sensor chips 8 are mounted one by one on the sensor substrate 9. In this case, while the sensor chips 8 are mounted based on a reference pattern (not shown) provided on the sensor substrate 9, the sensor chips 8 are likely to have displacement with respect to the reference pattern. For example, the sensor chips 8 are deviated (displaced) with respect to the reference pattern in the X-axis direction by approximately 20 μm.

Subsequently, the glass members 51, 52 and 53 are stuck together so that reference markers respectively provided on the glass members 51, 52 and 53 overlap with each other. For example, the reference marker of each of the glass members 51, 52 and 53 is stuck on the reference marker of another one of the glass members with X-axis direction accuracy of approximately 5 μm, and thus the accuracy of the sticking of the glass members 51, 52 and 53 is high. As above, in the imaging optical unit 1, the mounting process of the sensor chips 9 and the sticking process of the glass members 51, 52 and 53 are executed separately. Then, to the sensor substrate 9 with the sensor chips 8 mounted thereon, the glass members 51, 52 and 53 stuck together are fixed via a spacer (not shown).

Here, in the image reading device 100, the light receiving pixel 10 is larger than the irradiation region 30 as shown in FIG. 16A. Therefore, even when the displacement has occurred to the position of the opening 34 with respect to the light receiving pixel. 10 in the assembly process of the imaging optical unit 1, the amount of light received by the light receiving pixel. 10 does not change if the displacement amount is within a range of difference between the light receiving pixel 10 and the irradiation region 30 (e.g., difference between the X-axis direction width of the light receiving pixel 10 and the X-axis direction width of the irradiation region 30). Accordingly, in the image reading device 100, the permissible range of the assembly error of the glass members 51, 52 and 53 with respect to the sensor chips & can be made wide since the light receiving pixel 10 is larger than the opening 34.

### <Effect of First Embodiment>

According to the first embodiment described above, the image reading device 100 includes the glass member 53 having the surface 53a in superimposition with the light blocking member 11 having the plurality of openings 31 and the light blocking member 15 provided on the surface 53b of the glass member 53 on the side opposite to the surface 53a and having the plurality of openings 34 respectively corresponding to the plurality of openings 31. Further, the image reading device 100 includes the sensor substrate 9 and the imaging element unit 3 having the plurality of light receiving pixels 10 arrayed in the X-axis direction on the sensor substrate 9 and respectively corresponding to the plurality of openings 34. Since the light receiving pixel 10 is larger than the irradiation region 30 of the reflected light after passing through the opening 34, the opening 34 serves as the practical light receiving region of the light receiving pixel 10. With this configuration, even when the position of the opening 34 is displaced due to a temperature change, the irradiation region of the reflected light after passing through the opening 34 is included in the light receiving region of the light receiving pixel 10. Accordingly, even when a temperature change has occurred, the decrease in the amount of light received by each light receiving pixel 10 can be prevented further.

Further, according to the first embodiment, the width of the light receiving pixel 10 is larger than the opening width of the opening 34, and thus the irradiation region of the reflected light after passing through the opening 34 is included in the light receiving region of the light receiving pixel 10 even when the displacement has occurred to the position of the opening 34 with respect to the light receiving pixel 10 in the assembly process of the imaging optical unit 1. With this configuration, the amount of light received by each light receiving pixel 10 does not decrease. Accordingly, in the image reading device 100, the permissible range of the assembly error of the glass members 51, 52 and 53 with respect to the sensor chips 8 can be made wide.

Furthermore, according to the first embodiment, the plurality of light receiving pixels 10 are arrayed in the hound's tooth pattern. Accordingly, the interval between two light receiving pixels 10 adjoining in the X-axis direction can be made wide, and thus the effective diameter of the microlens 14 can be made large and the amount of light received by each light receiving pixel 10 can be increased.

### Second Embodiment

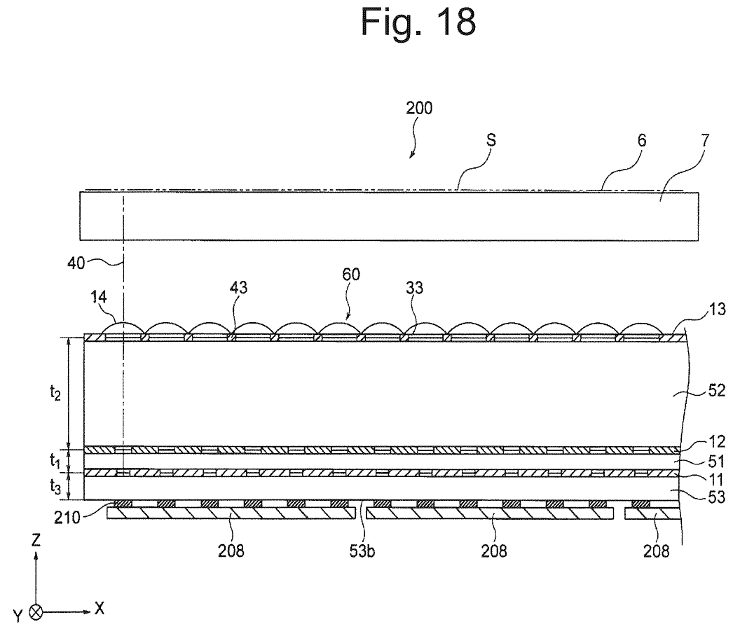

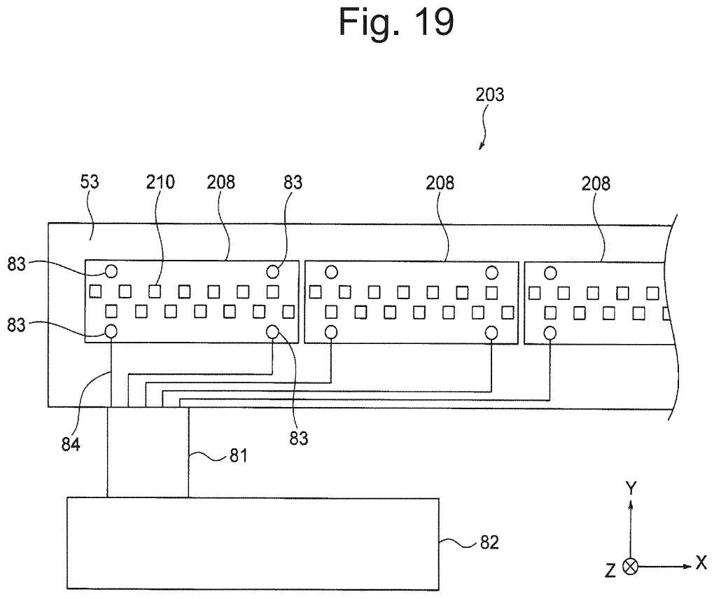

FIG. 18 is a cross-sectional view showing a configuration of an image reading device 200 according to a second embodiment. FIG. 19 is a plan view showing a part of the configuration of the image reading device 200 according to the second embodiment. In FIGS. 18 and 19, each component identical or corresponding to a component shown in FIG. 3 is assigned the same reference character as in FIG. 3. The image reading device 200 according to the second embodiment differs from the image reading device 100 according to the first embodiment in not including the light blocking member 15 and in that a plurality of light receiving pixels 210 are bonded to the glass member 53. Except for these features, the image reading device 200 is the same as the image reading device 100. Thus, FIG. 1 is referred to in the following description.

As shown in FIGS. 18 and 19, the image reading device 200 includes the plurality of microlenses 14, the glass member 52, the light blocking member 12, the glass member 51, the light blocking member 11, the glass member 53, the light blocking member 15 and an imaging element unit 203.

The imaging element unit 203 includes a plurality of (e.g., eight) sensor chips 208. Each of the plurality of sensor chips 200 includes a plurality of light receiving pixels 210. The plurality of light receiving pixels 210 are bonded to the glass member 53. As above, in the second embodiment, the glass member 53 has a function as a sensor substrate on which the plurality of light receiving pixels 210 are mounted.

As described earlier, the plurality of microlenses 14 are formed on the glass member 52. Since the linear expansion coefficients of the glass member 52 and the glass member 53 are equal to each other, even when a temperature change has occurred, the displacement amount of the light receiving pixel 210 and the displacement amount of the microlens 14 are equal to each other, and thus the displacement of the optical axis 40 of the microlens 14 with respect to the light receiving pixel 210 can be prevented. Accordingly, in the image reading device 200, the decrease in the amount of light received by each light receiving pixel 210 can be prevented. Namely, in the image reading device 200, the change in the amount of light received by each light receiving pixel 210 is small even when a temperature change has occurred.

In FIG. 18, the light receiving pixels 210 are bonded to the surface 53b as the glass member 53's surface on the −Z-axis side (i.e., surface on the light receiving pixels 10's side). Since the light receiving region of the light receiving pixel 210 is facing the document 6's side, the light receiving pixel 210 outputs an electric signal as a detection signal by receiving the reflected light traveling in the −Z-axis direction from the +Z-axis direction. In the second embodiment, the size of the light receiving pixel 210 is designed so that the light receiving pixel 210 has the same sensitivity as the opening 34 in the first embodiment. For example, the size of the light receiving pixel 210 is 35 μm×35 μm. Further, since the second embodiment is not provided with the light blocking member 15 (see FIG. 3) having the openings 34, the light receiving pixel 210 bonded to the surface 53b of the glass member 53 has the light receiving region for receiving the reflected light.

The image reading device 200 further includes electric wiring 84 as a wiring pattern provided on the surface 53b of the glass member 53 by means of printing. The electric wiring 84 is connected to the sensor chips 208. By this method, the sensor chips 208 are flip-chip mounted on the glass member 53. Further, the sensor chips 208 are mechanically and electrically connected to the glass member 53 via electric pads 83 provided on the surface of the glass member 53. The electric signal detected by the light receiving pixels 210 is outputted to an external circuit via the electric wiring 84 and the like. Specifically, the electric signal is outputted to a signal processing substrate 82 including an image processing circuit via the electric wiring 84 and a flexible cable 81. Signal amplification processing for amplifying the electric signal, signal processing for digitizing the electric signal, or the like is executed by using the outputted electric signal.

In the second embodiment, eight sensor chips 208 are arrayed in the X-axis direction, for example. The X-axis direction width of one sensor chip 208 is 12.5 mm, for example, which is smaller than the X-axis direction width of a generic sensor chip. Therefore, even when a temperature change has occurred, the displacement of the sensor chip 208 with respect to the glass member 53 can be reduced. Specifically, when the linear expansion coefficient of the glass member 53 is 7.0×10⁻⁶/° C. and the temperature change amount is 40° C., the displacement amount ΔX₁ of a part of the glass member 53 on which one sensor chip 8 is mounted (i.e., a part whose X-axis direction width is 12.5 mm) is 3.5 μm. On the other hand, when the linear expansion coefficient of silicon as the material of the sensor chip 208 is 3.0×10⁻⁶/° C. and the temperature change amount is 40° C., the displacement amount ΔX₂ of the sensor chip 208 is 1.5 μm. Accordingly, since the difference between the displacement amount ΔX₁ and the displacement amount ΔX₂ is a minute value of 2.0 μm, the displacement of the sensor chip 208 with respect to the glass member 53 can be reduced.

### <Effect of Second Embodiment>

According to the second embodiment described above, the plurality of microlenses 14 are provided on the glass member 52, and the plurality of light receiving pixels 210 are bonded to the glass member 53's surface 53b on the light receiving pixels 10's side. As above, in the second embodiment, the plurality of microlenses 14 and the plurality of light receiving pixels 210 are respectively provided on the glass members 52 and 53. With this configuration, even when a temperature change has occurred, the light receiving pixel 210 is situated on the optical axis of the microlens 14, by which the decrease in the amount of light received by each light receiving pixel 210 can be prevented.

Further, according to the second embodiment, since the light receiving pixel 210 is bonded to the surface 53b of the glass member 53, the irradiation region of the reflected light after passing through the opening 31 is included in the light receiving region of the light receiving pixel 210 even when the displacement has occurred to the position of the opening 31 with respect to the light receiving pixel 210 in the assembly process of the imaging optical unit. With this configuration, the amount of light received by each light receiving pixel 210 does not decrease. Accordingly, in the image reading device 200, the permissible range of the assembly error of the glass members 51, 52 and 53 with respect to the sensor chips 208 can be made wide.

### DESCRIPTION OF REFERENCE CHARACTERS

3, 203: imaging element unit, 9: sensor substrate, 10, 210: light receiving pixel, 11, 12, 13, 15: light blocking member, 14: microlens, 31, 32, 33, 34: opening, 51, 52, 53: glass member, 51a, 51b, 52a, 52b, 53a, 53b: surface, 84: electric wiring, 100, 200: image reading device

What is claimed is:

1. An image reading device comprising:
a first glass member having a first surface and a second surface as a surface on a side opposite to the first surface;
a plurality of condensing lenses provided on the first surface;
a first light blocking member provided on the second surface and having a plurality of first openings respectively corresponding to the plurality of condensing lenses;
a second glass member having a third surface in superimposition with the first light blocking member;
a second light blocking member provided on a fourth surface as a surface of the second glass member on a side opposite to the third surface and having a plurality of second openings respectively corresponding to the plurality of first openings;
a third glass member having a fifth surface in superimposition with the second light blocking member;
a third light blocking member provided on a sixth surface as a surface of the third glass member on a side opposite to the fifth surface and having a plurality of third openings respectively corresponding to the plurality of second openings; and
a sensor unit having a sensor substrate and a plurality of light receiving pixels arrayed in a predetermined array direction on the sensor substrate and respectively corresponding to the plurality of third openings.

2. The image reading device according to claim 1, wherein width of each of the plurality of light receiving pixels in the array direction is greater than opening width of each of the plurality of third openings in the array direction.

3. The image reading device according to claim 1 or 2, further comprising a fourth light blocking member having a plurality of fourth openings and arranged between the plurality of condensing lenses and the first glass member, wherein
the plurality of fourth openings are arrayed so as to correspond respectively to the plurality of condensing lenses, and
opening width of each of the plurality of fourth openings in the array direction is smaller than an effective diameter of each of the plurality of condensing lenses.

4. An image reading device comprising:
a first glass member having a first surface and a second surface as a surface on a side opposite to the first surface;
a plurality of condensing lenses provided on the first surface;
a first light blocking member provided on the second surface and having a plurality of first openings respectively corresponding to the plurality of condensing lenses;
a second glass member having a third surface in superimposition with the first light blocking member;
a second light blocking member provided on a fourth surface as a surface of the second glass member on a side opposite to the third surface and having a plurality of second openings respectively corresponding to the plurality of first openings;
a third glass member having a fifth surface in superimposition with the second light blocking member; and
a sensor unit having a plurality of light receiving pixels arrayed in a predetermined array direction and respectively corresponding to the plurality of second openings,
wherein the plurality of light receiving pixels are bonded to a sixth surface as a surface on a side opposite to the fifth surface.

5. The image reading device according to claim 4, further comprising a wiring pattern provided on the sixth surface and connected to the sensor unit.

6. The image reading device according to any one of claims 1 to 5, wherein the plurality of light receiving pixels are arranged at positions different from each other in the array direction.

7. The image reading device according to any one of claims 1 to 6, wherein the plurality of light receiving pixels are arrayed in a hound's tooth pattern.
